(19) United States
(12) Patent Application Publication
(10) Pub. No.: US 2003/0149226 A1
(43) Pub. Date: Aug. 7, 2003

(54) Methyltin catalysts for polyesterfication

(76) Inventors: Neal Douglas Conrad, Limerick, PA (US); Paul Mercando, Pennsburg, PA (US)

Correspondence Address: Nicholas J. DeBenedictis, Esq., ATOFINA Chemicals, Inc., Patent Department - 26th Floor, 2000 Market Street, Philadelphia, PA, 19103, US

(21) Appl. No.: 10/313,505

(22) Filed: Dec. 9, 2002

Related U.S. Application Data
(60) Provisional application No. 60/342,328, filed on Dec. 27, 2001.

(51) Int. Cl. C08G 63/78

(52) U.S. Cl. 528/283

(57) ABSTRACT

Methyltin compounds useful as catalysts in high-temperature esterification and polyesterification reactions are described. The esters and polyesters produced by the process possess superior physical/chemical properties such as improved color and thermal stability with less production of undesirable by-products. The greater stability of these catalysts allows their use in multistage polyesterification reactions and leads to lower use levels in some cases.

### BACKGROUND OF THE INVENTION

This invention relates to a method of manufacturing polyesters using selected, thermally stable methyltin compounds as catalysts even at process temperatures exceeding 225° C.

It has been known to use organotins as catalysts for esterification and polyesterification reactions, however, each of the existing processes have short comings such as excessive by-product formation, high color development or less of desirable end-product properties. Thus, there has been a need to identify new catalyst systems which would allow processing of esters and polyesters at elevated temperatures, i.e. above about 225° C. without generating the above listed problems. Selected mono and dimethyltin compounds meet these needs.

### DESCRIPTION OF THE PRIOR ART

Esterification and polyesterification reactions require very long reaction time to produce satisfactory products. The reaction time is significantly shortened in the presence of catalysts and heat. Various metal-containing compounds possessing catalytic activity have been used to shorten the reaction of ester and polyester processes. For example, antimony, titanium, lithium and organotin compounds. Of the organotin compounds used, the mono and dibutyltin compounds such as dibutyltin oxide are the most widely used. Methyltin compounds have also been reported as esterification and polyesterification catalysts. US patents listing methyltin compounds as esterification, transesterification and polyesterification catalysts include U.S. Pat. No. 3,157,618; U.S. Pat. No. 3,414,609; U.S. Pat. No. 3,322,983; U.S. Pat. No. 3,345,339; U.S. Pat. No 4,018,708; U.S. Pat. No. 4,973,737; U.S. Pat. No. 4,281,175; U.S. Pat. No. 4,473,702; U.S. Pat. No. 5,498,751; U.S. Pat. No. 5,594,785; and, U.S. Pat. No. 5,606,103

None of the above cited patents address specifically the problems associated with processing esters or polyesters at temperatures exceeding 225° C.

Recent patent publications dealing with the use of methyltin catalysts in ester and polyester manufacture is Japanese Patent Application # 61-68490, dated Mar. 28, 1986, assignee Turay Company, Ltd., Tokyo, Japan.

This publications discloses a process for the manufacture of polybutylene terephthalate by avoiding by-product formation of tetrahydrofuran. The catalyst employed is methylstannoic acid.

Another recent patent application, U.S. Pat. No. 5,891,985, dated Apr. 6, 1999., assignee E.D. DuPont de Nemours & Co. describes a soluble mono-alkylstannoic acid catalyst and a process for preparing high-molecular weight polyester polymer. The partial reaction product of methylstannoic acid with a glycol such as 1,4-butane diol disclosed. Esterification temperatures are 220° C. or less.

WO99/28368, application describes a preparation of esters and polyesters containing secondary hydroxyl groups. Catalyst employed may be C₁ to C₃ alkylstannoic acid, C₁ to C₃ alkyltin salt of carboxylic acid, C₁ to C₃ alkyltin oxide or halide or mixture. Process temperatures may reach 280° C. However, in comparative, example 1, dibutyltin oxide, butylstannoic acid and dimethyltin oxide were compared at equal tin content, the reaction mixture was heated to 225° C. and the relative activities of the three organotin catalysts were determined. The data, as stated, show that no improvement in esterification rate is observed regardless of the organotin catalyst when the diol contains only primary hydroxyl groups.

### SUMMARY OF THE INVENTION

This invention concerns the use of methyltin catalysts for the producing polyesters from polyester forming reactants. Superior polyester Properties are achieved, both physical properties and chemical properties along with faster reaction times and higher yields of the desired polyester through reduced production of undesirable byproducts from the polyester forming reactants such as low molecular weight ethers by the etherification of the polyol component of the reactants. Higher reactions temperatures are also achievable with the methyltin catalysts of the present invention with new and improved high-temperature processes for the manufacture of polyesters. Provided is an improved process for producing polyesters comprising combining polyester forming reactants with a catalytically effective amount of a methyl tin catalyst, and wherein said reactants includes a polyol and less than 50 mole % of said polyol is 1,4-butane diol and less than 50 mole % of said polyol is a secondary hydroxyl containing polyol. Improved polyesters produced by the process are also provided having a Gardner Color index value of less than about 2 and containing at least 0.01% by mole of a methyl tin catalyst. Shorter reaction times are provided with said methyltin catalysts especially when the temperature of said combination of reactants and catalyst is raised to greater than 240° C. during at least part of the reaction for producing polyester from said reactants. The instant invention is limited to reactions in which polyol reactants contain less than 50 mole percent of 1,4-butane diol or less than 50 mole % of a secondary hydroxyl containing diol, triol or polyol.

### DETAILED DESCRIPTION OF THE INVENTION AND PREFERRED EMBODIMENTS

Polyester Forming Reactants:

Reactants for producing polyesters are well known to the art and typically include a polyol and polycarboxylic acid. Some monomeric alcohols or monomeric acids can be included in the reactants and usually function as chain terminators. Those skilled in the art of producing polyesters usually select specific reactants based upon the desired properties of the resultant polyester, and on economic considerations. For example, when producing polyesters for use in the manufacture polyurethane foams, the polycarboxylic acid reactant usually includes a straight chain polycarboxylic acid such as adipic acid. When producing polyesters for use in resins especially for use in coatings or paints, isophthalic acid is often included as one of the polyester forming reactants. Suitable polyol reactants can be aliphatic, cycloaliphatic or aromatic and may or may not contain unsaturation and include isophthalic acid, terephthalic acid, trimellitic anhydride, phthalic anhydride, maleic anhydride, sebacic acid, hexahydrophthalic anhydride, dodecanedioc acid, adipic acid, 1,4-cyclohexane diacid. Equivalent anhydrides can also be used. Suitable polyols include, neopentyl glycol, 1,3-propanediol, 1,4-butanediol, 1,4-cyclohexyldimethanol, 1,6-hexanediol, 2-methyl-1,3-propanediol, 1,2-propylene glycol, trimethylol propane, trimethylol ethane, 2,2,4-trimethyl-1,3-pentane diol, pentaerythritol.

The mole ratio of polyol to polycarboxyl compound can be varied over a wide range. The preferred mole ratio ranges are from 0.5 to about 1.5 with 0.8 to 1.2 being more preferred.

Butyltin catalysts have been widely used commercially for producing polyesters. Examples of butyltin catalysts are: butyl stannoic acid, butyltin tris(2-ethylhexanoate), butylchlorotin dihydroxide, and dibutyltin oxide

Methyltin catalysts suitable for use in catalyzing ester and polyester from ester and polyester forming reactants include compounds of the formula MeₙSnX_{y} where X is selected from C₁ to C₁₆ carboxylic acids, chlorides, bromides, oxides, hydroxides, or mercaptides, and X can be the same or different n=1 or 2, and y=4−n. Preferred are methyl tin catalysts of the formula (Me)ₙSnX₍₄₋ₙ₎ wherein X is selected from C₁ to C₁₆ carboxylic acids and n is selected from a value of 1 to 2. Mixtures of different methyl tin catalysts can be employed in practicing the present invention Mixtures of methyl tin catalysts with other organotin catalysts such as butyl tin catalysts can be used.

Specific preferred methyl tin catalysts are monomethyltin triacetate (CH₃Sn(OAc)₃), dimethyltin bis(neodecanoate) (CH₃)₂Sn(neo-dec)₂, monomethyltin tris(2-ethylhexanoate), CH₃Sn(2-EHA)₃ and methylstannoic acid (Me Sn(O)(OH)) or anhydride [(MeSnO_{1.5})ₓ]

Undesirable by-products from the polyester forming reactants include aldehydes and ethers that result from polyol decomposition or from the etherification reaction of polyols such as glycols. To compensate for the loss of polyol reactant to undesirable by-products, excess polyol reactant is added to the reactor, 1 to 4% by weight of polyol reactants is the typical range of excess polyol charged to the reactor. A substantial advantage provided by the present invention is the savings resulting from reducing the polyol charge to the reactor while still producing a polyester with a desired hydroxyl number. The loss in polyol during a polyesterification reaction in which butyltin tris(2-ethylhexanoate) was used as the catalyst at 260° C. was 4.6% by weight of neopentyl glycol. The loss in polyol was reduced to 3.9% with methyltin tris(2-ethylhexanoate) at 260° C. This is a 15% reduction in the loss of polyol during the reaction.

Reaction temperature. Based upon our discovery that methyl tin catalysts are more thermally stable than their butyl tin homologues, higher reaction temperatures can be employed in the polyester forming reaction. The temperature of the polyester forming reactants during the reaction can be raised to greater than 240° C. during at least part of the reaction for producing polyester from said reactants. Temperatures as high as 260° C. can be employed.

In the following examples, several different types of polyester resin formulations were used to demonstrate the advantages of the methyl tin catalysts verses butyltin catalysts in producing polyesters from various of polyester forming reactants. All parts used in the examples are by weight unless otherwise stated.

### EXAMPLES A, B, 1 AND 2.

In examples A, B, 1 and 2, polyester forming reactants were used for making a polyester resin of the type used in the paint industry for making solvent borne coatings. These coatings would include solvent borne polyester polyurethane coatings and solvent borne polyester melamine coatings. With this formulation a significant key advantage verses butyltin catalyst was low color. A paint manufacturer can not use a polyester that has a color darker (more yellow) than Gardner 2, because it would impact the final color of the coating. These polyesterification reactions were run at 260° C. Generally butyltin catalyzed reactions of polyester forming reactants are not run at such high temperatures because in the presence of a butyltin catalyst too much color is generated in the resulting polyester and significant quantities of reactants are converted into undesirable by-products. The methyltin catalyzed polyesters had Gardner colors equal to Gardner 2; whereas, the butyltin tris(2-ethylhexanoate) system had a Gardner equal to 6. The reaction temperature of 260° C. is approaching the upper limit for the methyltin catalyst, but it does show the extreme difference between methyl tin and butyltin catalyst. Table 1 has the polyester forming reactants and the data for the polyester produced. The target acid value of the polyester is 3-4 mg KOH/g polyester. A second issue with polyesterification reactions at temperatures in excess of 225° C. is loss of glycol by the production of undesirable byproducts resulting from side reactions. It is apparent from the data below that use of a butyl tin catalyst at 260° C. promotes more etherification than the methyltin catalyst. The reaction rates were very similar. At this extreme temperature it is difficult to see differences in reaction rate because even weak catalysts can be effective at 260° C.

TABLE 1

| Example | Ex. A | EX. 1 | Ex. 2 | Example B |
|---|---|---|---|---|
| Raw Material | Weight | Weight | Weight | Weight |
| Adipic acid | 50.23 grams | 50.208 | 50.21 grams | 50.21 grams |
| Isophthalic acid | 228.41 grams | 228.302 | 228.40 grams | 228.39 grams |
| Neopentyl glycol | 178.98 grams | 178.909 | 179.03 grams | 179.12 grams |
| Trimethylol | 23.08 grams | 23.052 | 23.14 grams | 23.09 grams |
| propane | | | | |
| Catalyst | 0.5504 grams | 0.5571 grams | 0.1597 grams | 0.356 grams |
| Catalyst | 0.025 mol % | 0.027 mol % | 0.026 mol % | 0.016 mol % |
| concentration | | | | |
| Reaction | 260 | 260 | 260 | 235 |
| Temperature ° C. | | | | |
| Reaction time | 160 min | 150 min | 150 min | 240 min |
| Polyester | | | | |
| Properties | | | | |
| Color | Yellow | Pale yellow | Pale yellow | Colorless |
| Acid value | 3.4 mgKOH/g | 3.6 mgKOH/g | 3.5 mgKOH/g | 3.3 mgKOH/g |
| OH value | 48.8 mgKOH/g | 53.4 mgKOH/g | 51.6 mgKOH/g | 53.3 mgKOH/g |
| Mw | 12,000 | 12,000 | 13,000 | 12,000 |
| Mn | 3,200 | 3,000 | 3,000 | 3,000 |
| PD | 3.7 | 4.0 | 4.2 | 3.9 |
| Gardner color | 6 | 2 | 2 | <1 |
| APHA color | >500 | 170 | 200 | 20 |
| Melt viscosity @ | 4.23 poise | 3.67 poise | 4.21 poise | 4.04 poise |
| 200° C. | | | | |
| Tg by DSC | 25.4° C. | 26.2° C. | 25.9° C. | 26.5° C. |
| Catalyst | BuSn(2-EHA)₃ | MeSn(2-EHA)₃ | MeSnO(OH) | BuSn(2-EHA)₃ |

As used herein MeSn(2-EHA)₃ stands for is monomethyltin tris(2-ethylhexanoate BuSn(2-EHA)₃ stands for butyltin tris (2-ethylhexanoate), and MeSnO(OH) is methylstannoic acid. M_{w}, Mₙ=weight average and number average molecular weight respectively units=g/mole. PD=polydispersity (M_{w}/Mₙ). The polyester composition for examples A, B, 1, and 2, was designed to produce a polyester with physical properties that were based on published values that are known in the industry.

In Table 1, all the polyesters were prepared at 260° C. except Example B. As a control experiment, Example B, a polyester from the same polyester forming reactants was prepared at 235° C. in the presence of butyltin tris(2-ethylhexanoate) catalyst. Note the reaction time was much longer, 240 minutes instead of the 150 minutes for the methyltin catalyst at 260° C. The hydroxyl value in the final polyester was greater when BuSn(2-EHA)₃ was run at 235° C. than at 260° C. The acid numbers of Examples A and B indicate the same degree of reaction occurred in both. This supports the concept that at higher temperatures more etherification occurs resulting in a polyester with a lower hydroxyl value and a net loss in glycol. The polyester prepared at 235° C. with BuSn(2-EHA)₃ has a hydroxyl value of 53.3 mg KOH/g, but that value drops when BuSn(2-EHA)₃ is used at 260° C. to 48.8 mg KOH/g. The hydroxyl value of the MeSn(2-EHA)₃ catalyzed polyester at 260° C. is similar to BuSn(2-EHA)₃ at 235° C. The higher hydroxyl value at comparable degree of reaction is desirable in the final resin.

### EXAMPLES C, 3, AND 4

In examples, C, 3 and 4, a formulation of polyester forming reactants was used that is typical of the type of reactants used to make a polyester polyol useful for making polyurethane powder coatings as opposed to solvent borne coatings of the above examples. The results are summarized in Table 2. These examples substantiate that additional advantages are obtained with the methyltin catalyst verses the equivalent butyltin catalyst. Under the reactions conditions utilized color improvement was not as dramatic as in the previous examples however, reaction rate and hydroxyl value were significantly improved verses the butyltin catalyst. The methyltin catalyst is faster than the butyltin catalyst both at 245° C. and 255° C. Surprisingly, the methyltin catalyst is not substantially faster at 255° C. than at 245° C. With the methyl tin catalyst the reaction time for completion of the polyesterification reaction is 210-225 minutes. With BuSn(2-EHA)₃ the reaction time is 300 minutes at 245° C. and 260 minutes at 255° C. Even at 225 minutes methyltin catalyst is 25% faster than BuSn(2-EHA)₃ at 245° C. Note, the polyester prepared with BuSn(2-EHA)₃ had an acid value of 4.4 instead of <3. Therefore, this reaction had not reached completion and it should have been reacted for longer than 300 minutes. Reactions of 260° C. were not run with these reactants because of expected color (Gardner=>2). The data in Table 2 shows the significant increase in reaction rate (shorter reaction time) with the methyltin catalyst and more side reactions with the butyltin catalyst With the methyltin catalyst at 255° C. the hydroxyl value was 35, it drops down to 24 to 29 with monobutyltin tris(2-ethylhexanoate). The lower hydroxyl value for the polyester produced with the same polyester forming reactants in the same proportion proves that with butyltin catalyst more of the glycol reactant is lost due to the formation of undesirable, generally volatile, etherification byproducts verses the methyltin catalyst. In example C where the polyester is produced with butyltin tris(2-ethylhexanoate) at 255° C. the loss in polyol reactant is 4.4 % by weight based on polyol; however in comparative example 3, where the polyester is catalyzed with methyltin tris(2-ethylhexanoate) at 255° C. the loss in polyol reactant is only 2.4% by weight of polyol. Using the methyltin tris(2-ethylhexanoate) as the catalyst has the advantage of reducing the loss in polyol reactant by approximately 50%.

An advantage of being able to carry out the reaction at higher temperature is that reaction time is significantly shortened allowing more productions cycles to be run in the reactor. However, if higher production rate is not needed the advantage of the methyl tin catalyst can be realized in higher quality polyester if the reaction is run at the same temperature as a butyltin catalyzed reaction. Superior polyester in terms of color are produced with the methyl tin catalysts according to the present invention especially when aliphatic polycarboxylic acids are included in the polyester forming reactants, as shown in the examples with adipic acid.

TABLE 2

| Example | | | | | |
|---|---|---|---|---|---|
| number | Ex C | Ex. 3 | Ex. 4 | Ex D | Ex 5 |
| Raw | Weight | Weight | Weight | Weight | Weight |
| Material | | | | | |
| Isophthalic | 285.99 | 285.95 | 286.13 | 286.11 | 285.97 |
| acid | | | | | |
| Neopentyl | 183.11 | 183.01 | 183.14 | 183.12 | 183.13 |
| glycol | | | | | |
| Trimethylol | 12.18 | 12.31 | 12.19 | 12.21 | 12.17 |
| propane | | | | | |
| Catalyst | 0.5545 | 0.5099 | 0.5390 | 0.5485 | 0.5120 |
| Catalyst | 0.026 mol % | 0.026 mol % | 0.027 mol % | 0.026 mol % | 0.026 mol % |
| concentration | | | | | |
| Reaction | 260 min | 225 min | 210 min | 300 min | 225 min |
| time | | | | | |
| Reaction | 255° C. | 255° C. | 255° C. | 245° C. | 245° C. |
| Temp | | | | | |
| Color | colorless | colorless | colorless | Colorless | colorless |
| Acid value | 4.4 | 2.1 | 1.7 mgKOH/g | 4.4 | 3.6 |
| | mgKOH/g | mgKOH/g | | mgKOH/g | mgKOH/g |
| OH value | 24.4 | 34.8 | 35.4 | 28.9 | 31.05 |
| | mgKOH/g | mgKOH/g | mgKOH/g | mgKOH/g | |
| Mw | 11,000 | 12,000 | 11,000 | 13,000 | 10,000 |
| Mn | 3,200 | 3,600 | 3,100 | 3,500 | 3,300 |
| Pd | 3.4 | 3.4 | 3.5 | 3.6 | 3.0 |
| Gardner | <1 | <1 | <1 | <1 | <1 |
| color | | | | | |
| APHA color | 50 | 50 | 40-50 | 30-40 | 40 |
| Melt | 12.1 poise | | 12.4 poise | 14.0 poise | 15.5 poise |
| viscosity @ | | | | | |
| 200° C. | | | | | |
| Tg by DSC | 54.4° C. | 56.4° C. | 56.5° C. | 54.9 | 56.1 |
| Catalyst | BuSn(2-EHA)₃ | MeSn(2-EHA)₃ | BuSn(2-EHA)₃ | BuSn(2-EHA)₃ | MeSn(2-EHA)₃ |

See Table one for explanations.

We claim:

1. An improved process for producing polyesters comprising combining polyester forming reactants with a catalytically effective amount of a methyl tin catalyst and wherein said reactants includes a polyol and less than 50 mole % of said polyol is 1,4 butane diol and less than 50 mole % of said polyol is a secondary hydroxyl containing polyol.

2. The improved process of claim 1 wherein the temperature of said reactants is raised to greater than 225° C. during at least part of the esterification reaction for producing polyester and less than 4% by weight volatile ether byproducts are produced from said reactants based upon the weight of polyester forming reactants.

3. The improved process of claim 1 wherein said catalyst is a methyl tin of the formula (Me)ₙSnX₍₄₋ₙ₎ wherein X is selected from C₁ to C₁₆ carboxylic acids and n is selected from a value of 1 to 2 to produce a polyester from said reactants.

4. The improved process of claim 1 wherein said temperature is raised to above 250° C.

5. The improved process of claim 1 wherein said temperature is raised to above 255° C.

6. An improved polyester produced by the process of claim 1 and having a Gardner Color index value of less than about 2 and containing at least 0.01 mole % of a methyl tin catalyst.

7. The improved polyester of claim 6 wherein the methyl tin is monomethyltin tris(2-ethylhexanoate), CH₃Sn(2-EHA)₃

8. The improved polyester of claim 6 wherein the methyl tin is monomethyltin triacetate, CH₃Sn(OAc)₃

9. The improved process of claim 1 wherein said catalyst is dimethyltinbis(neodecanoate).

10. The improved process of claim 2 wherein said catalyst is monomethyltin tris(2-ethylhexanoate), and the process produces less of said byproducts in comparison to using monobutyltin tris(2-ethylhexanoate) as the catalyst

11. The improved process of claim 1 wherein the methyl tin catalyst comprises at least 0.01 mole % of the combination

12. The improved polyester of claim 8 wherein the methyl tin catalyst is present in the combination from about 0.01% by mole to about 0.2% by mole

13. The improved process of claim lwherein a butyl tin catalyst is used in combination with the methyl tin catalyst.

14. The polyester produced by the process of claim 13.

15. The polyester produced by the process of claim 5 wherein a butyl tin catalyst is used in combination with the methyl tin catalyst.

16. The improved process of claim 1 wherein a non-tin containing co-catalyst is used in combination with the methyl tin catalyst.

17. The polyester produced by the process of claim 6 wherein a non-tin containing co-catalyst is used in combination with the methyl tin catalyst.

18. The improved process of claim 1 wherein the catalyst is MeSnXₙY₃₋ₙ wherein X is selected from C₁ to C₁₆ carboxylic acids and Y is selected from C₁ to C₁₆ carboxylic acids, chlorides, bromides, oxides, hydroxides, or mercaptides, and n is selected from a value of 1 or 2.

19. The improved process of claim 1 wherein the catalyst is a mixture of (Me)SnXY_{(3-n) and Me}₂SnXY wherein X is selected from C₁ to C₁₆ carboxylic acids and Y is selected from C₁ to C₁₆ carboxylic acids, chlorides, bromides, oxides, hydroxides, or mercaptides, and n is selected from a value of 1 to 2.
